(19) United States
(12) Patent Application Publication
(10) Pub. No.: US 2003/0132939 A1
(43) Pub. Date: Jul. 17, 2003

(54) Interactive navigation through real-time live video space created in a given remote geographic location

(76) Inventors: Levin Moshe, Wilmington, DE (US); Ido Mordechal, Nolania (IL)

Correspondence Address: BLANK ROME COMISKY & MCCAULEY, LLP, 900 17TH STREET, N.W., SUITE 1000, WASHINGTON, DC, 20006, US

(21) Appl. No.: 10/220,609

(22) PCT Filed: Feb. 28, 2001
(86) PCT No.: PCT/US01/06248

(51) Int. Cl. G06T 15/70

(52) U.S. Cl. 345/474

(57) ABSTRACT

A plurality of cameras (103) observe a space (101) and provide real-time video signals (S). A local server (201) receives the signals (S) and generates virtual video signals for transmission over the Internet (303) to remote users' devices (305). Each remote user is provided with an interface (401) for virtual navigation within the space (101). Upon receiving a remote user's navigation command, the local server (201) adjusts the virtual video signal to show what the user would see if the user were actually moving within the space (101). The virtual video signal is produced for each user, so that the users can virtually navigate independently.

### REFERENCE TO RELATED APPLICATION

The present application claims the benefit of U.S. Provisional Application No. 60/186,302, filed Mar. 1, 2000, whose disclosure is hereby incorporated by reference in its entirety into the present disclosure.

### BACKGROUND OF THE INVENTION

1. Field of the Invention

The present invention relates to simultaneous video and image navigating of a plurality of users in a given three dimensional space covered by plurality of cameras.

In addition, the invention relates to efficient distribution of video data over the Internet to maximize the number of simultaneous user of the network over a given set of system resource (servers etc.)

2. Description of the Related Arts

Real and still remote video system are based on the coverage of a given space by a multiplicity of video and digital cameras. The cameras may be fixed or mobile. One way to cover a given area is to cover it with a sufficient number of cameras and to provide to the user the output of all these cameras. This method is inefficient since it requires from the user a selection from several sources of information (and if the space to be covered is large then from many cameras). However, the strongest limitation comes from the requirement to provide the video picture to a remote user via the Internet or an intranet. In this case the required bandwidth to provide the coverage will be too high.

Another technique to cope with this problem is to use a mechanically moving camera. The commands from the user (which can be carried from a local source or from a remote source over the Internet or Intranet) moves the camera via a mechanical actuator. The main limitation of this solution is that it is limited to one user only, thus prohibiting multiple usage of cameras.

### SUMMARY OF THE INVENTION

The first object of this invention is a system to provide a system that allows a plurality of customers to simultaneously navigate in a predefined three dimensional space covered by a multiplicity of cameras.

The second object of this invention is to provide a method for smooth navigating within the plurality of cameras. The user should be able to move from one camera view field to the adjacent camera view field with a minimum disturbance in the quality of the real time video picture and a minimum of distortion of the images.

The third objective of this invention is to provide an efficient algorithm which learns the users' behaviors and optimizes the data flow with the network (consisting of location to be covered, immediate server, remote servers and users).

The fourth objective of this invention is to provide to the system constructor, a tool to insert a graphic indicator (icon) to an arbitrary three dimensional location within the space to be covered. When the remote user will encounter this point in the three dimensional space while navigating, the icon will appear on his screen on the appropriate position, and if he chooses to click on this icon, some associated group of applications will be activated.

The invention thus provides a system for user interactive navigating in a given three dimensional space providing pictures and videos that are produced from any combination of real time video, recorded video and pictures generated by a plurality of still video cameras, moving video cameras and digital cameras, allowing the operation of space referenced icons. The system allows a plurality of users to navigate via remote or local access to introduce navigation commands: up, down, left, right, forward, back, zoom in and zoom out and a combination of the above commands.

These commands are interpreted by a navigation algorithm, which forwards to the user an appropriate video or still picture that has been produced from the real images. While navigating in the picture, the user will be presented specific icons in predetermined locations. Each of these icons will activate a specific predetermined application.

The navigation is done by software selection of the appropriate set of memory area from the appropriate plurality of cameras and the proper processing and image synthesis thus allowing a multi access of the user to the same area (camera).

In order to support simultaneous user operation, an efficient distribution of the image and video data over the Internet is required. The invention includes a distributed optimization algorithm for optimal distribution of the data according to the demand distribution.

The invention can be used with the invention disclosed and claimed in PCT/US00/40011, which calculates the optimal number of cameras required to cover a predefined three dimensional area with a required quality.

Load sharing techniques are native to network application. The present invention provides a dedicated algorithm based on neural networks or other optimization techniques, which learns the geographical distribution in relation to a given server's location and decides on the geographical location of the various compression/de-compression algorithms of the video signal. In addition, the algorithm specifies the amount of data to be sent to a specific geographical location.

### BRIEF DESCRIPTION OF THE DRAWINGS

The above and other objects, features and advantages of the present invention will become apparent from the following description, taken in conjuncture with the accompanying drawings in which:

FIG. 1 is a view for describing the three dimensional model of the area to be covered by the plurality of cameras.

FIG. 2 is a view the information flow among the various elements of the FIG. 1 cameras and local server.

FIG. 3 is a conceptual view of a network having a plurality of cameras, the local server, a plurality of Internet servers world-wide and a plurality of users which are using the system to browse the said space.

FIG. 4 is a conceptual description of the navigation process from the remote user's point of view.

FIG. 5 is a preferred embodiment view of the command bar for all the navigation commands available to the user.

FIG. 6 is a view of the process of integrating adjacent video pictures.

FIG. 7 is a view of typical icons inserted within the user screen once a predetermined three dimensional coordinate is within the view of the user virtual view filed.

### DETAILED DESCRIPTION OF THE INVENTION

The present invention will hereafter be described with reference to the accompanying drawings.

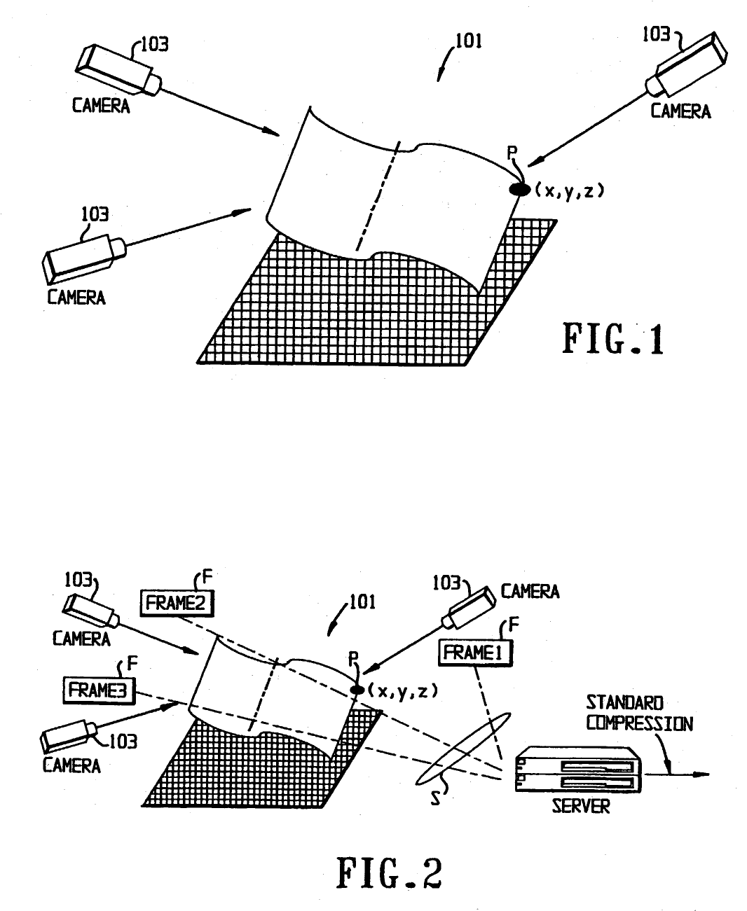

FIG. 1 is a view for describing the three dimensional model of the area 101 to be covered by a plurality of cameras 103, including a specific point P whose coordinates are (x,y,z). The coverage optimization algorithm determines each camera location and azimuth. Considerations for this algorithm are areas to be covered and the quality of coverage required. In the preferred embodiment of the invention, the cameras will be located to create a coherent continuous real time video picture, similar to the video picture that one gets when physically navigating in the above mentioned space.

FIG. 2 is a view of the information flow between the various elements of FIG. 1. Each camera 103 produces a continuous stream S of digital video signals made up of frames F. All these streams S are stored within the local server 201. The local server 201 receives navigation commands from the users and forwards them to the remote servers. The network management module analyzes the required capacity and location and accordingly sends the required block of information.

In order to present realistic looking pictures from a cluster of cameras (with almost the same center of projection) the pictures are first projected onto a virtual 3D surface and then using the local graphics renderer are reprojected into the image.

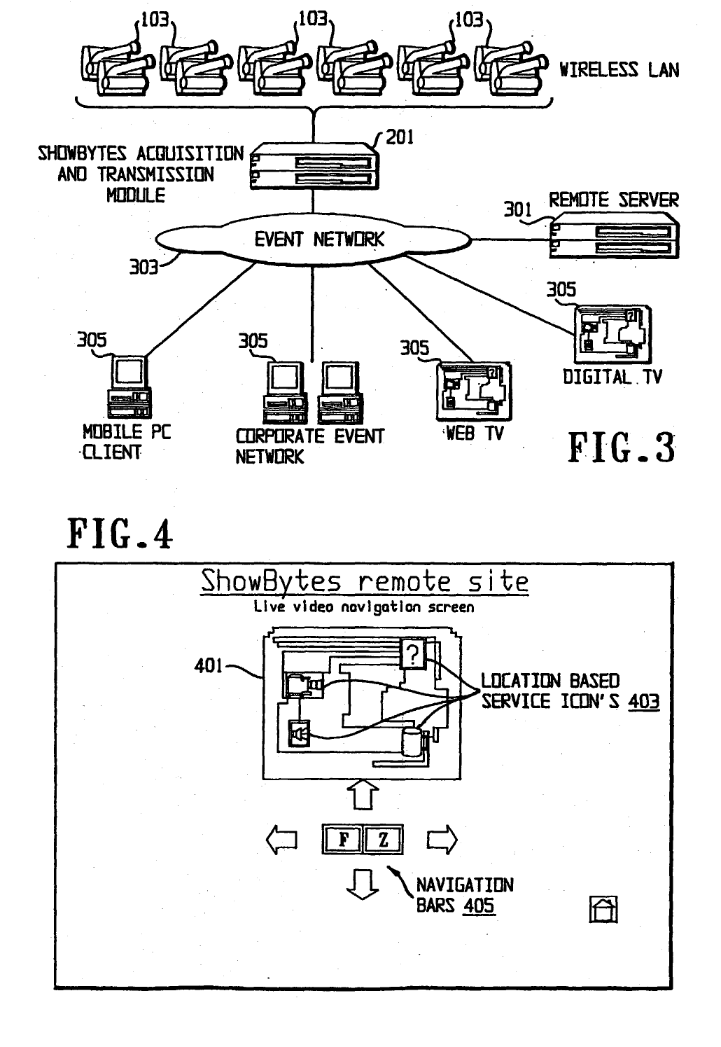

FIG. 3 is a conceptual view of the whole network including the plurality of cameras 103 each located in a predetermined location. The local server 201 or a network of servers collect the video streams S from the plurality of cameras and run a network management system that controls the flow of the above-mentioned information and remote servers 301 which forward the information over the Internet 303 (or another suitable communication network) to the users' devices 305. The user will have a dedicated application running on that user's device 305, which will allow the user to navigate within the said space.

FIG. 4 is a view of the navigation process from the user's point of view. The figure provides a snapshot of the computer screen, which operates the video navigation application. In the in the preferred embodiment, the user will have an interface 401 similar to a typical web browser. That interface 401 includes location-based server icons 403 and a navigation bar 405 having navigation buttons.

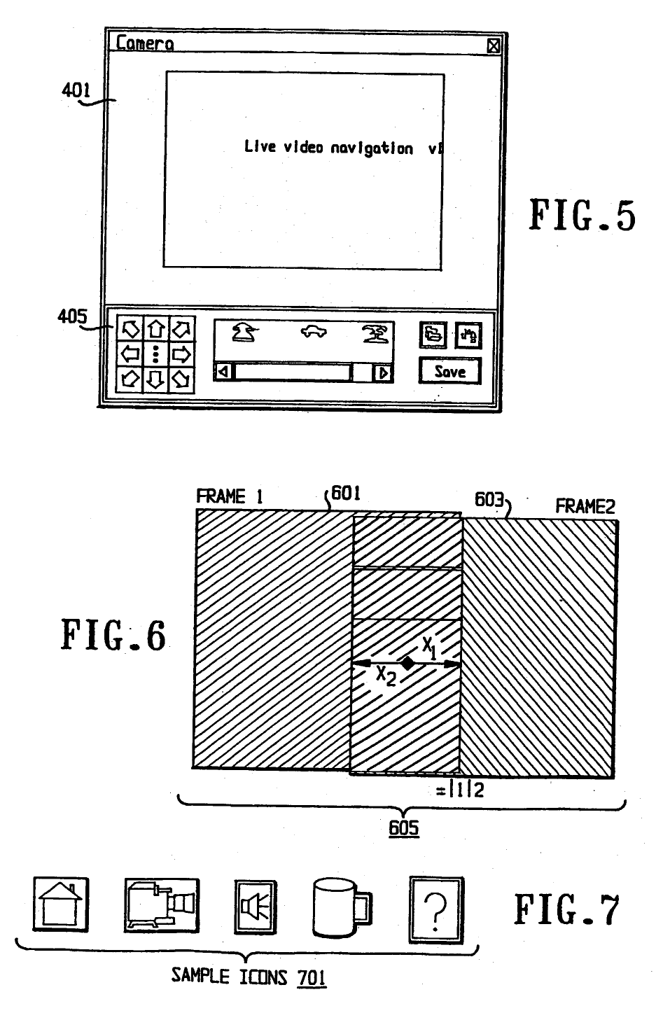

FIG. 5 is a view of all the navigation commands available to the user through the interface 401:

Up—This command moves the view point of the user (the virtual picture) up, in a similar way to head movements.

Down—This command moves the view point of the user down (similar to head movements)

Right, Left—These commands move the view point right/left (similar to head movements)

Zoom in/Zoom out—These commands applied a digital focus operation within the virtual picture in a way similar to eye focus.

Walk Forward—This command moves the user's view point forward in a way similar to body movements.

Walk backward—This command moves the user's view point back in a way similar to body movements.

Open map—This command opens a map of the whole covered space with the location of the user “virtual location” is clearly marked. The map will be used by the user to built a cognitive map of the space.

Hop to new location—the viewer will be virtually transferred to a new location in the space.

Hop forward/Hop back—the viewer will be virtually transferred to a previously hopped to location in the space.

FIG. 6 is a view of the process of integrating adjacent video pictures 601, 603 into a single virtual picture.

For each pixel in the virtual picture, n=the number of cameras covering this area will be identified according to the projection of the line of sight over the view point.

If n=1, then the virtual picture value is the real picture value.

If n>1, the virtual picture value is a weighted average of the pixels of the various pictures, where the weight is set according to the relative distance of the pixel from the picture boundary.

In the preferred embodiment, the pixel will be set according to parametric control interpolation. Without loss of generality we will assume that there are two pictures P₁ and P₂ overlapping with nₒ pixels. The distances e₁ and e₂ indicate the distance (in pixels) from the pixel under test to the edge of the picture. V₁ and V₂ are two three dimensional vectors depicting the color of the pixel.

V, the vector describing the color of the pixel in the virtual picture, is given by:

$${V}_{i} = \frac{{\sum }_{j = 1}^{n} {{V}_{j , i} ( \frac{{e}_{j} - {x}_{j}}{{e}_{j}} )}^{p}}{{\sum }_{j = 1}^{n} {( \frac{{e}_{j} - {x}_{j}}{{e}_{j}} )}^{p}}$$

Alternatively, a parameter can be included for object size normalization dependent on different camera distances from object.

In the above equation, p is the power parameter which sets the level of interleaving between two pictures. For p=0 the average is without weighting and we expect strong impact from one picture over the other. For very large values of p (p>>1) we expect the value of V to be the value of the pixel with the largest distance to the edge the frame. The value of the parameter will be set after field trails.

FIG. 7 is a view of the typical icons 701 inserted within the user's screen once a predetermined three dimensional coordinate is within the view of the user virtual view field.

The invention suggested here includes an edit mode, which enable the user (typically the service provider) to insert floating icons. In the edit mode, the operator will be able to navigate in the space and add from a library of icons an icon, which is connected to a specific three-dimensional location.

Further, while editing, the user will attach to each icon an application, which will be operated by double clicking. Typical applications are web browsing, videoconference session etc., detailed description of a product, hopping to other location etc.

While a preferred embodiment has been set forth above, those skilled in the art who have reviewed the present disclosure will appreciate that other embodiments can be realized within the scope of the invention. For example, other techniques can be used for combining the frames F from the various cameras. Also, the invention does not have to use the Internet, but instead can use any other suitable communication technology, such as dedicated lines. Therefore, the present invnetion should be construed as limited only by the appended claims.

We claim:

1. A system for permitting a plurality of users to view a space, the system comprising:
a plurality of cameras for taking real-time video images of the space and for outputting image signals representing the real-time video images; and
a server for (i) receiving navigation commands from the plurality of users, (ii) using the real-time video images to form a virtual video image for each of the plurality of users in accordance with the navigation commands received from each of the plurality of users so that each of the plurality of users sees the space as though that user were physically navigating in the space, and (iii) transmitting the virtual video image to each of the plurality of users.

2. The system of claim 1, wherein the server is in communication with the plurality of users over the Internet.

3. The system of claim 1, wherein the server forms the virtual video image by interpolation from pixels of the real-time video images.

4. The system of claim 3, wherein, in the interpolation, each of the pixels of the real-tire video images is weighted in accordance with a distance of said each of the pixels from an edge of a corresponding one of-the real-time video images.
